(19) United States
(12) Patent Application Publication
(10) Pub. No.: US 2013/0159096 A1
(43) Pub. Date: Jun. 20, 2013

(54) RANKED USER GRAPH FOR SOCIAL ADVERTISEMENT TARGETING

(71) Applicants: Ram Santhanagopal, Sunnyvale, CA (US); Arvind Thirunarayanan, San Jose, CA (US); Katrina Illari, San Jose, CA (US); Bret Thaeler, San Jose, CA (US)

(72) Inventors: Ram Santhanagopal, Sunnyvale, CA (US); Arvind Thirunarayanan, San Jose, CA (US); Katrina Illari, San Jose, CA (US); Bret Thaeler, San Jose, CA (US)

(21) Appl. No.: 13/329,070

(22) Filed: Dec. 16, 2011

(51) Int. Cl. G06Q 30/02

(52) U.S. Cl. 705/14.49

(57) ABSTRACT

A method, advertising network, and computer program product for constructing a ranked user graph for advertisement targeting. The method commences by selecting a user from a set of candidate users from a first internet site, then identifying membership of the user in at least one second internet site. Having the intersecting membership, then assembling a set of one or more relationship associations between the user and a set of the user's associates (e.g. as retrieved from the second internet site). The relationship associations have various aspects that relate the user to a particular associate, and scoring or ranking of those various aspects are used in applying weights the relationship associations. Privacy settings are applied in order to filter out certain associations and/or to restrict propagation of information that the user or other authority deems as private information. The ranked user graph is used in delivering advertising to the user's associates.

### FIELD

The present disclosure is directed towards social advertisement targeting, and more particularly toward constructing a ranked user graph for advertisement targeting.

### BACKGROUND

The Internet is populated with various sites hosting communities, some of such communities having a huge user base. Examples include email services, messenger services, desktop application sites (e.g. contact management, address book, etc), and so on. Considered in pairs or groups, many of these sites have a significant number of overlapping users, and relationships between one user and another user at one or more of these sites could be used in targeted internet advertisements toward friends, or friends of friends. Especially when the size of the aggregate user base is large, and the overlap is large, and the number of relationships (e.g. first degree, second degree, etc) is large, the use of friends or friends of friends (or any sort of associate) could be used effectively in internet advertising. However, legacy attempts have proven deficient.

In some legacy systems, multiple functions from within a single site have been considered when aggregating users and their friends. For example, some legacy systems have aggregated users and created user graphs using data deriving from a popular internet mail site (e.g. inferring user's friends and associates via mail sent and mail received logs). Similarly, some legacy systems have aggregated users and created user graphs using messenger sites (e.g. using a static buddy list, messenger chat history, etc). In some situations, a user's friends and associates are available directly from a user's online address book, and certain social data (e.g. social connections, favorites, etc) has been used to create user graphs.

Still, legacy systems have failed in many regards, particularly when multiple internet sites are desired to be aggregated, and particularly when the user graph is desired to be ranked. Thus, techniques for constructing a ranked user graph for advertisement targeting is needed.

Other features and advantages will be apparent from the accompanying drawings, and from the detailed description that follows below.

### SUMMARY

Embodiments include a method, an advertising network, and a computer program product for constructing a ranked user graph for use in presenting online advertisements to a user's associates (e.g. friends, friends of friends, etc). The method commences by selecting a user from a set of candidate users from a first internet site, then identifying membership of that user in at least one second internet site. Having the intersecting membership, then assembling a set of one or more relationship associations between the user and a set of the user's associates (e.g. associates as retrieved from the second internet site). The relationship associations have various aspects that relate the user to a particular associate, and scoring or ranking of those various aspects are used in applying weights to a user graph (e.g. a social graph), thus constructing a ranked user graph. Privacy settings are applied in order to filter out certain associations and/or to restrict propagation of information that the user or other authority deems as private information. The ranked user graph is used in delivering advertising to the user's associates.

### BRIEF DESCRIPTION OF THE DRAWINGS

The novel features are set forth in the appended claims. However, for purpose of explanation, several embodiments are set forth in the following figures.

FIG. 1A is a schematic of an environment for constructing a ranked user graph for advertisement targeting, according to some embodiments.

FIG. 1B is a flow chart overview of a system for constructing a ranked user graph for advertisement targeting, according to some embodiments.

FIG. 2 is a data flow diagram of a system for constructing a ranked user graph for advertisement targeting, according to some embodiments.

FIG. 3 is a schematic of an advertising network for constructing a ranked user graph for advertisement targeting, according to some embodiments.

FIG. 4A is a graphic representation a ranked user graph for advertisement targeting, according to some embodiments.

FIG. 4B is a textual representation a ranked user graph for advertisement targeting, according to some embodiments.

FIG. 5 depicts a block diagram of a system to perform certain functions of a computer system.

FIG. 6 depicts a block diagram of an instance of a computer system suitable for implementing an embodiment of the present disclosure.

Like reference characters refer to corresponding parts throughout the drawings.

### DETAILED DESCRIPTION

Reference will now be made in detail to various embodiments, some examples of which are illustrated in the accompanying drawings. It will be understood that the described embodiments are not intended to limit the scope of the claims. On the contrary, the embodiments are intended to cover alternatives, modifications and equivalents, which may be included within the scope of the appended claims. Furthermore, in the following detailed descriptions, numerous specific details are set forth in order to provide a thorough understanding of the exemplary embodiments. However, one of ordinary skill in the art can recognize that the present advances may be practiced without these specific details. In other instances, well known methods, procedures, components, and circuits have not been described in detail so as avoid unnecessarily obscuring aspects of the described embodiments.

Some portions of the detailed descriptions which follow are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etcetera as may be used herein is generally conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions using terms such as “processing” or “computing” or “communicating” or “instantiating” or “registering” or “selecting”, or “displaying” or the like, refer to the action and processes of a computer system or similar electronic computing device that manipulates and transforms data represented as physical (electronic) quantities within the computer system's registers and memories into other data similarly represented as physical quantities within the computer system memories or registers or other such information storage, transmission or display devices.

### Section I: General Terms

Some of the terms used in this description are defined below (in alphabetical order) for easy reference. These terms are not rigidly restricted to these definitions. A term may be further defined by the term's use in other sections of this description.

“Ad” (e.g. ad, item and/or message) means a paid announcement, as of goods or services for sale, preferably on a network such as the internet. An ad may also be referred to as an item and/or a message.

“Ad server” is a server that is configured for serving one or more ads to user devices. An ad server is preferably controlled by a publisher of a website and/or an advertiser of online ads. A server is defined below.

“Advertiser” (e.g. messenger and/or messaging customer, etc) means an entity that is in the business of marketing a product and/or a service to users. An advertiser may include, without limitation, a seller and/or a third-party agent for the seller. An advertiser may also be referred to as a messenger and/or a messaging customer. Advertising may also be referred to as messaging.

“Advertising” means marketing a product and/or service to one or more potential consumers by using an ad. One example of advertising is publishing a sponsored search ad on a website.

“Application server” is a server that is configured for running one or more devices loaded on the application server. For example, an application server may run a device configured for deducing shadow profiles.

“Client” means the client part of a client-server architecture. A client is typically a user device and/or an application that runs on a user device. A client typically relies on a server to perform some operations. For example, an email client is an application that enables a user to send and receive email via an email server. In this example, the computer running such an email client may also be referred to as a client.

“Database” (e.g. database system, etc) means a collection of data organized in such a way that a computer program may quickly select desired pieces of the data. A database is an electronic filing system. In some instances, the term “database” is used as shorthand for a “database management system”. A database may be implemented as any type of data storage structure capable of providing for the retrieval and storage of a variety of data types. For instance, a database may comprise one or more accessible memory structures such as a CD-ROM, tape, digital storage library, flash drive, floppy disk, optical disk, magnetic-optical disk, erasable programmable read-only memory (EPROM), random access memory (RAM), magnetic or optical cards, etc.

“Device” means hardware, software or a combination thereof. A device may sometimes be referred to as an apparatus. Examples of a device include, without limitation, a software application such as Microsoft Word™ or a database; or hardware such as a laptop computer, a server, a display; or a computer mouse and/or a hard disk.

“Network” means a connection, between any two or more computers, that permits the transmission of data. A network may be any combination of networks including, without limitation, the internet, a local area network, a wide area network, a wireless network, and/or a cellular network.

“Publisher” means an entity that publishes, on a network, a web page having content and/or ads, etc. ad/or publishes, on a network, a downloadable application and/or other digital context having digital content and/or digital ads, etc.

“Server” means a software application that provides services to other computer programs (and their users) on the same computer or on another computer or computers. A server may also refer to the physical computer that has been set aside to run a specific server application. For example, when the software Apache HTTP Server is used as the web server for a company's website, the computer running Apache may also be called the web server. Server applications may be divided among server computers over an extreme range, depending upon the workload.

“Social network” or “social networking website” means a networked software application having user accounts (e.g. nodes) that are coupled by using one or more interdependencies such as, for example, friendship, kinship, common interest, financial exchange, dislike, sexual relationship, beliefs, knowledge and/or prestige. Examples of a social network include, without limitation, Facebook™, Twitter™, Myspace™, Delicious™, Digg™, and/or Stumble Upon™.

“Software” means a computer program that is written in a programming language that may be used by one of ordinary skill in the art. The programming language chosen should be compatible with the computer on which the software application is to be executed and, in particular, with the operating system of that computer. Examples of suitable programming languages include, without limitation, Object Pascal, C, C++ and/or Java. Further, the functions of some embodiments, when described as a series of steps for a method, could be implemented as a series of software instructions for being operated by a processor such that the embodiments could be implemented as software, hardware, or a combination thereof. Computer-readable media are discussed in more detail in a separate section below.

“System” means a device or multiple coupled devices. A device is defined above.

“User” (e.g. consumer, etc) means an operator of a user device. A user is typically a person who seeks to acquire a product and/or service. For example, a user may be a woman who is browsing Yahoo!TM Shopping for a new cell phone to replace her current cell phone. The term “user” may also refer to a user device, depending on the context.

“User device” (e.g. computer, user computer, client and/or server, etc) means a single computer or a network of interacting computers. A user device is a computer that a user may use to communicate with other devices over a network, such as the internet. A user device is a combination of a hardware system, a software operating system, and perhaps one or more software application programs. Examples of a user device include, without limitation, a laptop computer, a palmtop computer, a smart phone, a cell phone, a mobile phone, an IBM-type personal computer (PC) having an operating system such as Microsoft Windows™, an Apple™ computer having an operating system such as MAC-OS, hardware having a JAVA-OS operating system, and/or a Sun Microsystems™ workstation having a UNIX operating system.

“Web browser” means a software program that may display text or graphics or both, from web pages on websites. Examples of a web browser include, without limitation, Mozilla Firefox™ and Microsoft Internet Explorer™.

“Web page” means documents written in a mark-up language including, without limitation, HTML (hypertext mark-up language), VRML (virtual reality modeling language), dynamic HTML, XML (extensible mark-up language), and/or other related computer languages. A web page may also refer to a collection of such documents reachable through one specific internet address and/or through one specific website. A web page may also refer to any document obtainable through a particular URL (uniform resource locator).

“Web portal” (e.g. public portal) means a website or service that offers a broad array of resources and services such as, for example, email, forums, search engines, and online shopping malls. The first web portals were online services, such as AOL, that provided access to the web. However, now, most of the traditional search engines (e.g. Yahoo!™) have transformed themselves into web portals to attract and keep a larger audience.

“Web server” is a server configured for serving at least one web page to a web browser. An example of a web server is a Yahoo!^{TM} web server. A server is defined above.

“Website” means one or more web pages. A website preferably includes a plurality of web pages virtually connected by links or URL addresses to form a coherent group.

### Section II: Descriptions of the Figures

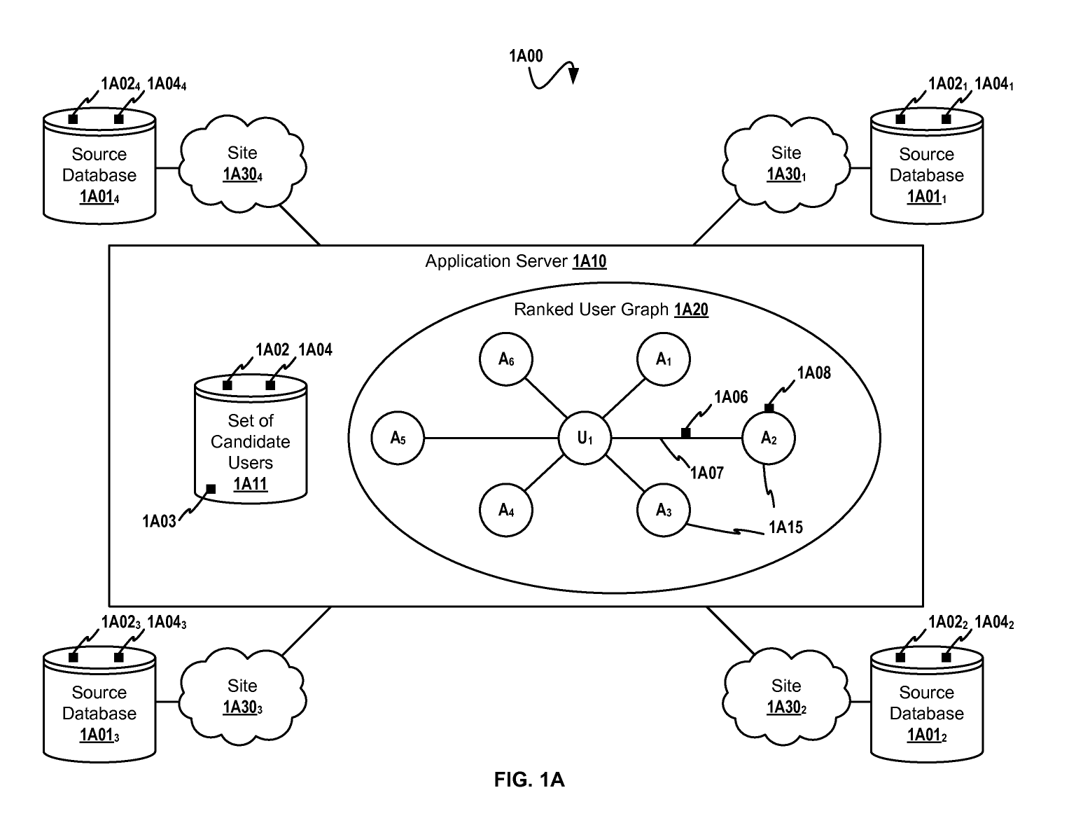

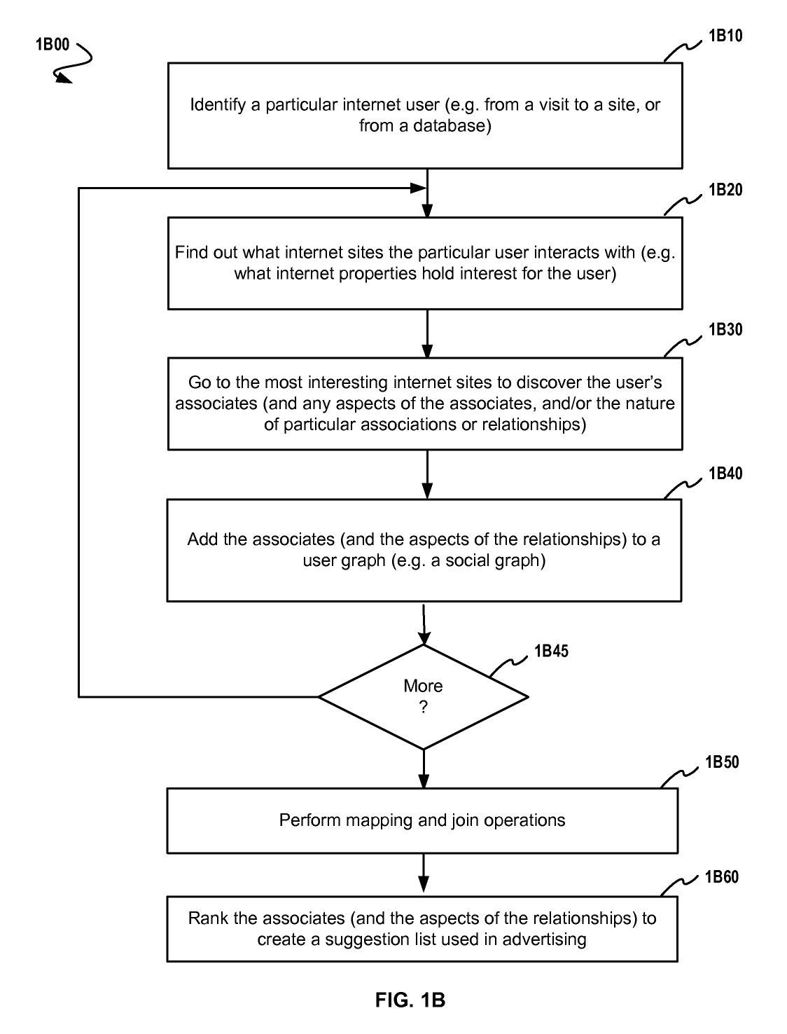

FIG. 1A is a schematic of an environment for constructing a ranked user graph for advertisement targeting. As an option, the present environment 1A00 may be implemented in the context of the architecture and functionality of the embodiments described herein. Also, the environment 1A00 having interrelated systems or any aspect therein may be implemented in any desired environment.

As shown, the environment 1A00 comprises internet sites (e.g. internet site 1A30₁, internet site 1A30₂, internet site 1A30₃, internet site 1A30₄, etc), which sites host (directly or indirectly) one or more source databases (e.g. source database 1A01₁, source database 1A01₂, source database 1A01₃, source database 1A01₄, etc). The data contained in such a source database includes user information in the form of one or more instances of a user record 1A02 (e.g. user record 1A02₁, user record 1A02₂, user record 1A02₃, user record 1A02₄, etc), which also includes information pertaining to other internet site users, including the user's friends or associates codified in the form of one or more instances of an associate record (e.g. associate record 1A04₁, associate record 1A04₂, associate record 1A04₃, associate record 1A04₄, etc).

Thus, in such an environment 1A00, a server (e.g. ad network application server 1A10) can read contact information from the source databases, select a particular user (e.g. user U₁), retrieve additional information pertaining to the selected user, and retrieve information pertaining to the selected user's associates (e.g. associate A₁, associate A₂, associate A₃, etc). Such associates can be other personalities that are referred to in any of the particular user's user record. Given a relationship between a user and an associate, or multiple relationships between a user and a plurality of associates, a user graph (e.g. of nodes and edges) can be constructed. Relationship information can be attached or coded into or onto such a user graph, and one or more scoring techniques can be used to rank the nodes and/or edges, thus constructing a ranked user graph 1A20. For example, a relationship between user U₁ and associate A₂ can be graphed as an edge (e.g. relationship association 1A06), and the edge can hold any number of aspects of the relationship between user U₁ and associate A₂. Of course the foregoing is merely an example, and a relationship between a user and the user's associates can be graphed as edges, and the edges each can hold any number of aspects of the relationship between the user and the user's associates. Moreover, the set of associates can be graphed as nodes, and the nodes can hold any number of aspects of the corresponding associates (e.g. associate aspect 1A08).

In such an environment, an ad network application server 1A10 can implement a method for constructing a ranked user graph for social advertisement targeting. Such a method includes operations to retrieve a set of candidate users 1A11 from a first internet site, select a subject user 1A03 from a first internet site (possibly using the a set of candidate users 1A11), and then to identify aspects of membership of the subject user in another internet site. Once such a membership has been established, it can be used to assemble a set of the user's associates 1A15 together with sufficient relationship information (e.g. relationship associations, edges) such that a user graph can be constructed and a weight applied to at least some of the relationship associations 1A07 to create a ranked user graph 1A20.

Further, techniques can be applied in order to filter out certain associations and to restrict propagation of information that the user or other authority deems as private information (e.g. to observe privacy rules). Additionally, some embodiments employ source ranking techniques when identifying an aspect of membership. For example, the membership of the subject user in another internet site might be of particular significance (e.g. high rank) with respect to advertising (for example if the membership comprised membership in a social media site). Or the membership of the subject user in another internet site might be deemed as a priori insignificant (e.g. low rank) with respect to advertising. Performing such ranking serves to prioritize the ‘crawling’ activities used to determine aspects of the membership of the subject user in another internet site.

FIG. 1B is a flow chart overview of a system for constructing a ranked user graph for advertisement targeting. As an option, the present system 1B00 may be implemented in the context of the architecture and functionality of the embodiments described herein. Also, the system 1B00 or any aspect therein may be implemented in any desired environment.

As shown, the system 1B00 serves to identify a particular internet user (e.g. a subject user) from a visit to an internet site, or from a database, or from any other means to identify an internet user (see operation 1B10). Of course a particular internet user (referring to a real person) can be known by any number of handles or aliases that refer to the particular internet user (being the aforementioned real person). An alias-to-user or alias-to-person map can be constructed such that relationships between an alias or handle and any number of associates (or their aliases or handles) can nevertheless relate the real person of the user to the real persons of the user's contacts.

With at least some information about the particular user beyond merely an alias, it is possible to find out what internet sites the particular user interacts with, for example, what internet properties hold interest for the user (see operation 1B20). Such information can be gathered using any number of known techniques, including use of browser logs, cookies, etc. Then, an application server can determine the “most interesting internet sites” (e.g. most frequently visited, most time spent at a domain, etc), and navigate to the “most interesting internet sites” to discover the identity (e.g. by alias, by handle, or possibly by a real person's name). In some cases an application server can enumerate not only the user's associates, but can also list any aspects of the associates and/or the nature of particular associations or relationships (see operation 1B30).

The enumerated associates and the aspects of the relationships can then be added to a user graph (e.g. a social graph, see operation 1B40), which in turn can be analyzed and annotated to create a ranked user graph. In some embodiments, there may be a plurality of “most interesting internet sites”, and the operations 1B10 through operation 1B40 can be repeated to further enumerate associates and aspects of the relationships (see decision 1B45 and loop to operation 1B20) which can then be added to a user graph.

It should be recognized that an associate of a subject user discovered at one internet site might be the same person as the same associate even though the associate is known by a different alias at each internet site. Various techniques can be used to identify a real person who is the same associate, even though the associate is known by different names on different internet sites. For example, database join operations (see operation 1B50) are employed to identify a real person (or a common internet personality) that is the same associate, even though the associate is known by different names on different internet sites. The associates can now be scored and ranked so as to facilitate formation of a suggestion list (see operation 1B60), which suggestion list can be used to present relevant advertisements to the associates of the subject user.

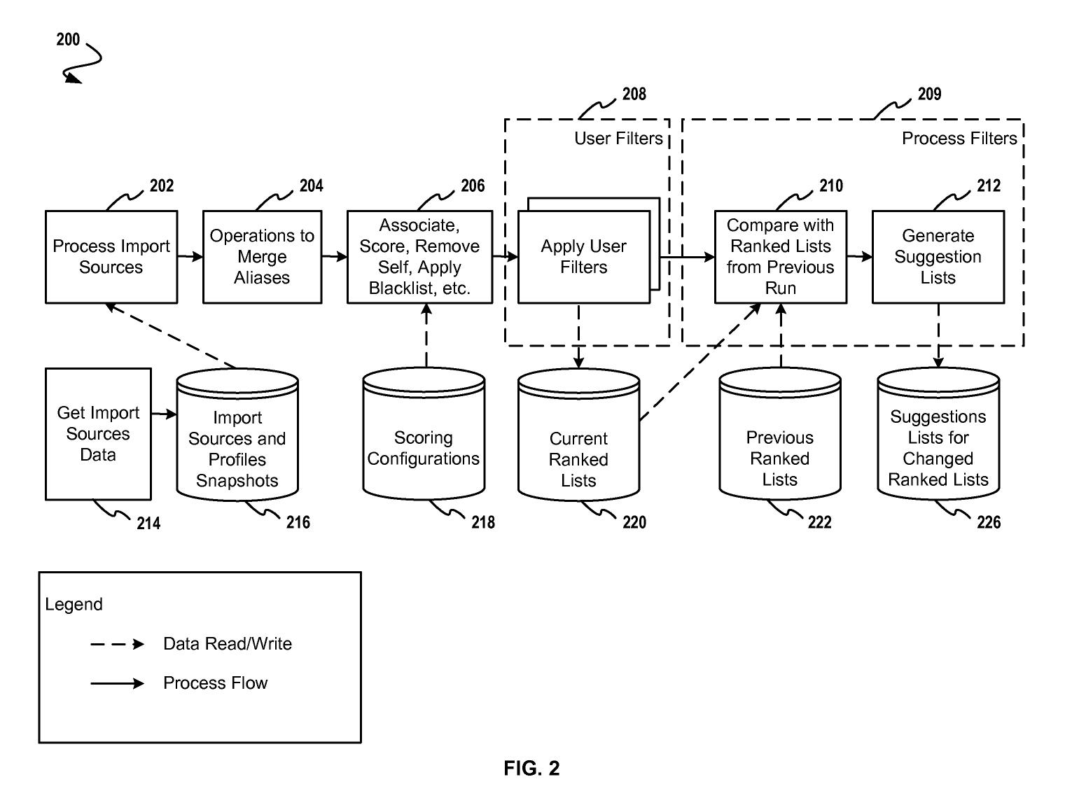

FIG. 2 is a data flow diagram of a system for constructing a ranked user graph for advertisement targeting. As an option, the present system 200 may be implemented in the context of the architecture and functionality of the embodiments described herein. Also, the system 200 or any aspect therein may be implemented in any desired environment.

As shown, the data flow proceeds in a flow, traversing from the operation to process import sources 202, through the operation to generate suggestion lists 212. The process flow is exemplified by the operations (shown as rectangles) in the data flow and certain data elements (shown as database icons) are exemplified repositories for data.

The system 200 commences by processing import sources. Again referring to the operation 1B10 to identify an internet user, and again referring to the operation 1B20 to consider what internet sites hold interest for the user, an operation to process import sources 202 can parse a wide range of data, store the data in a wide range of databases, as well as store the data in a wide range of representations. For example, the operation to process import sources 202 can import sources from the internet user's contacts, and/or from the internet user's “friends”, and/or from the internet user's “friend of a friend”, and/or from the internet user's “followers”, and/or from the internet user's messenger contacts, and/or from the internet user's blog site(s), etc.

Of course, any of the internet sites that hold interest for the user can host databases that contain such relationships (e.g. friends, followers, other associates, etc) and any one more more internet sites might list multiple associates by an alias or handle that is referring to the same person. Accordingly, such multiple associates are merged into a single associate record (e.g. associate record 1A04₁, associate record 1A04₂, associate record 1A04₃, associate record 1A04₄, etc), which can be the basis for a node representing a unique associate. The operation to merge aliases 204 depicts but one possible embodiment of such merging. Merging can be done based on information stored in a database that maps handles across various internet sites or based on commonalities between associate records. Other techniques are reasonable and possible as well.

Thus, the system 200, having identified a subject user (e.g. from a set of candidate users retrieved from a first internet site) and having identified membership of the subject user in at least one second internet site now assembles a user graph comprising relationship associations between the subject user and a set of unique associates. Yet, the user graph resulting from the foregoing has not yet been subjected to the scoring and ranking techniques of operation 206. As depicted, the scoring and ranking techniques of operation 206 can be configured, and a configuration can include not only numeric type scoring, but also techniques for ranking, binning, and filtering. Moreover numeric scoring can include both quantitative scoring techniques as well as qualitative scoring techniques. Strictly as an example, a scoring configuration might include rules (e.g. opt-out rules, privacy rules, user filter rules, etc) to prune or mark a user graph so as to apply a blacklist (e.g. associates that are known to the system 200, and should be removed from further consideration). Or, strictly as an example, a scoring configuration might include rules to prune or to mark a user graph so as to remove associates that are deemed to be an alias of the subject user, and thus should be removed from further consideration.

Having a user graph in the desired form, one or more techniques for scoring can be applied. As an example, given a representation of a ranked user graph 1A20, the scoring and ranking techniques of operation 206 can applying a weight (e.g. a score) to at least some of the relationship associations.

The data flow of system 200 proceeds to operations to apply any one or more user filters 208. Again, strictly as an example, the user filters can include operations to filter out certain associates based on a user profile. Such a profile can specify a user's preferences for explicitly hiding associations or associates, and/or to explicitly deny the formation of any association with a given associate. In such rules, the associate can be specified by any convenient identification mechanism (e.g. by alias or handle, etc). The operations to apply the user filters 208 can also include application of privacy rules and/or privacy actions, and such rules or actions can have its source in either governmental regulations, or in user preferences, or both. The user filters can denote preference actions taken by associates. Other filters can be embodied as system-level process filters (e.g. see process filters 209) to filter a set of associates to form a subset of the set of associates using one or more relationship associations. In some situations, application of system-level process filters can affect the graphs of all users in which an associate may appear. For instance a user might set a preference for “opt out of the experience”, or might “mark profile as private”, or might “enable abuse filters”. The applied user filter rules can have the effect of eliminating one or more associates from the ranked user graph, or the applied user filter rules can have the effect of updating the ranked user graph (e.g. updating the edge between the subject user and an associate), and the update can be applied as relationship association 1A06. Alternatively, the applied privacy rules can have the effect of updating the ranked user graph updating the node of an associate, and the update can be applied to the ranked user graph as an associate aspect 1A08.

In some embodiments, the differences between an updated instance of a ranked user graph and a previously stored copy of a ranked user graph can influence downstream operations. For example, one difference might be the existence of a new associate or new friend of a friend, etc. And an advertising server can use such information (e.g. as provided in a suggestion list) in determining what ads to show to the associates.

Given a ranked user graph (whether different or not from any previously stored copy of a ranked user graph) associates can now be considered so as to facilitate formation of a suggestion list, which suggestion list can be used to present relevant advertisements to the associates of the subject user.

The flow as exemplified in the operations of system 200 is supplanted by reading and writing data items, which data items are formed and/or used by the operations. In particular, applicable data items include data (e.g. profiles, user attributes, etc) retrieved from sources (see operation to get import sources data 214) and stored in a profile database 216. Scoring configurations can be codified and stored in a scoring configuration database 218. Still additional databases are present in system 200 and used by the operations. For example, some of the top row of operations consider the differences between an updated instance of a ranked user graph and a previously stored copy of a ranked user graph in order to influence downstream operations. Accordingly, databases such as the current ranked user lists 220 and previously ranked user lists 222 are retrieved by various operations, including the operation to compare ranked lists 210 and the operation to generate suggestion lists 212. As shown, the operation to generate suggestion lists 212 stores suggestion lists in a suggestion list database 226.

### Networked Systems for Online Advertising

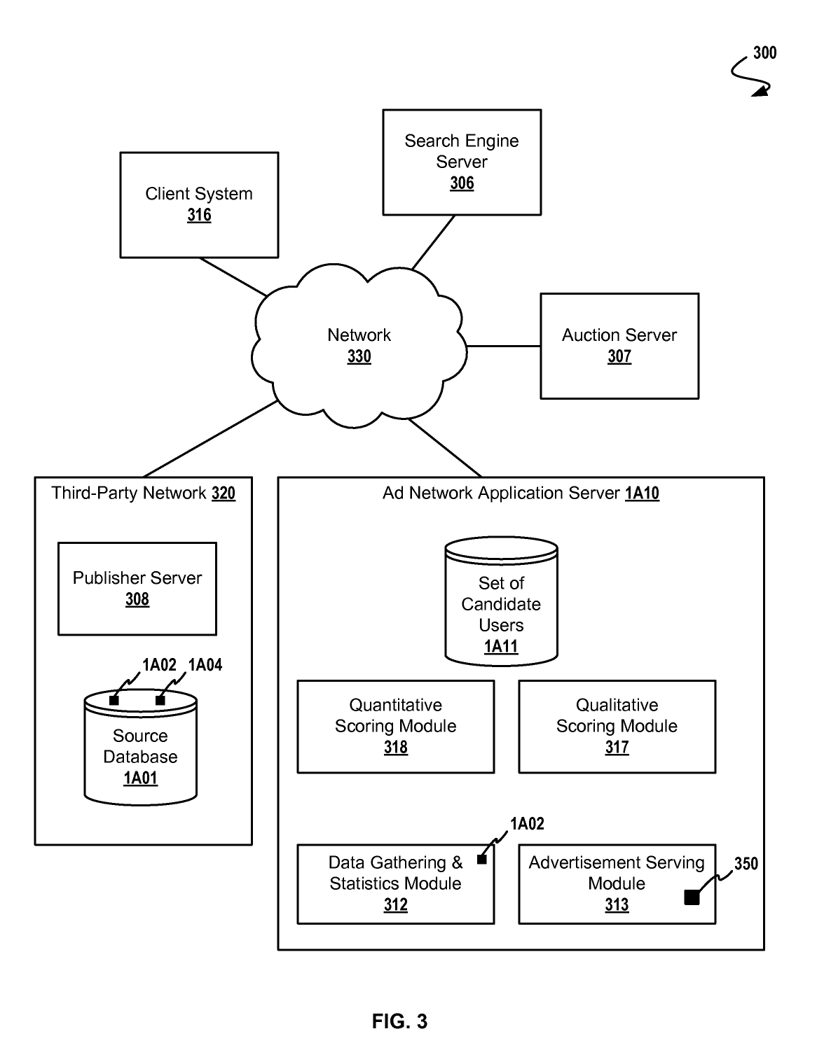

FIG. 3 is a schematic of an online advertising network for constructing a ranked user graph for advertisement targeting. As an option, the present online advertising network 300 may be implemented in the context of the architecture and functionality of the embodiments described herein. Also, the online advertising network 300 or any aspect therein may be implemented in any desired environment.

Placement of advertisements within an internet environment (e.g. online advertising network 300 of FIG. 3) has become common. As shown, network nodes are organized into a network such than an internet advertiser or agent may select a particular property (e.g. Yahoo.com or other internet site), and may create an advertisement such that whenever any internet user, via a client system 316, renders the web page from the selected property (possibly using a search engine server 306), the advertisement is composited on the web page by one or more servers (e.g. a server within a third-party network 320 and/or an ad network application server 1A10) for delivery to a client system 316 over a network 330. Given this generalized delivery model, and using techniques disclosed herein, sophisticated online advertising might be practiced. Moreover the online advertising network 300 may involve third-party participants in the internet ad ecosystem, providing a wide range of aspects for prosecuting internet advertising campaigns. Although the system is intended to gather data from systems owned by a single entity (e.g. Yahoo), the system can also import data from 3^{rd} party data providers to infer relationships and further expand user graphs to include additional relationships. Again referring to FIG. 3, an internet property (e.g. embodied in a publisher server 308) might be able to attract internet visitors, which visitors may have any arbitrary interest, demographic, target predicates, or other attributes. In fact, a publisher server 308, possibly in conjunction with a data gathering and statistics module 312, can access a source database 1A01 to identify details as pertains to user behavior and relationships between a subject user's data (e.g. as gathered from a user record 1A02) and data pertaining to one or more associates (e.g. as gathered from an associate record 1A04). Thus, an internet user's behaviors, demographics and interests might be ‘known’ in quite some detail as pertains to a wide range of user queries, interest categories, or other demographics or attributes. Also, behaviors of the subject user's associates might be known in quite some detail based on the available data in totality. Thus, for a particular subject user, ads corresponding to the demographics of the particular subject user's associates may be served as advertisements 350 retrieved from an advertisement serving module 313. In some situations, reaching a particular demographic is commercially competitive, so advertisements retrieved from an advertisement serving module 313 might undergo steps to resolve such competition, possibly in conjunction with an auction server 307.

In some implementations of an online advertising network 300 the scoring and ranking techniques of operation 206 include not only numeric type scoring, but also techniques for ranking, binning, and filtering. Moreover numeric scoring can include both quantitative scoring techniques (see quantitative scoring module 318) as well as qualitative scoring techniques (see qualitative scoring module 317).

In some embodiments, the online advertising network 300 might host a variety of modules to serve management and control operations (e.g. a data gathering and statistics module 312, an advertisement serving module 313, etc) pertinent to managing contracts and for serving advertisements to users. In particular, the modules, network links, algorithms, assignment techniques, serving policies, and data structures embodied within the online advertising network 300 might be specialized so as to perform a particular function or group of functions reliably while observing capacity and performance requirements. As an example, an advertising network application server can operate partly in an offline (or batch) mode, and partly in a real-time (or interactive) online mode. Any one or more modules within an online advertising network 300 can operate cooperatively to implement a system for constructing ranked user graphs for use in social advertisement targeting.

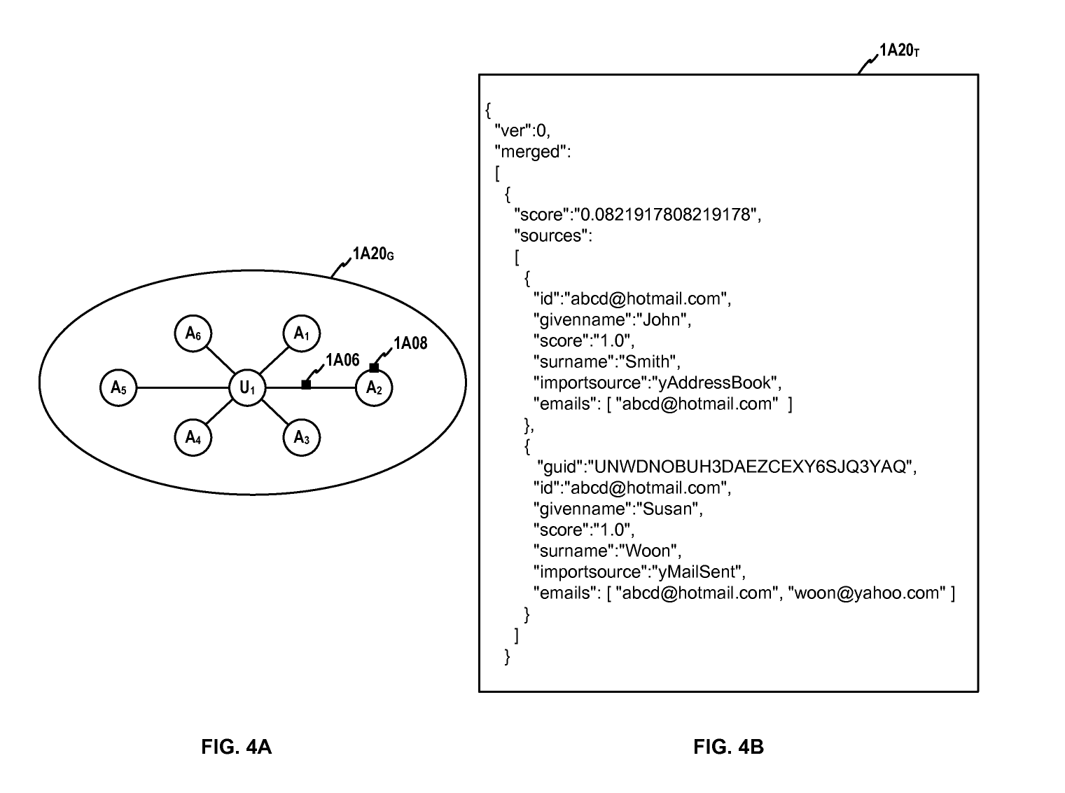

FIG. 4A is a graphic representation of a ranked user graph 1A20_{G} for advertisement targeting. As an option, the present graphic representation may be implemented in the context of the architecture and functionality of the embodiments described herein. Also, the graphic representation or any aspect therein may be implemented in any desired environment.

The graphic representation shown is a visual rendering of a computer-readable representation of a ranked user graph 1A20_{G}. In some cases, such a computer-readable representation of a ranked user graph is stored as an object (e.g. an object in an object-oriented programming language), or it can be stored in a vector representation such as in a scalable vector graphics (SVG) representation.

FIG. 4B is a textual representation a ranked user graph 1A20_{T} for advertisement targeting. As an option, the present textual representation may be implemented in the context of the architecture and functionality of the embodiments described herein. Also, the textual representation or any aspect therein may be implemented in any desired environment.

The textual representation shown is a visual rendering of a computer-readable representation of a ranked user graph 1A20_{T}. In some cases, such a computer-readable representation of a ranked user graph is stored as an object (e.g. an object in an object-oriented programming language), or it can be stored in an markup language representation such as in a extensible markup language (XML), or JavaScript Object Notation (JSON), or in some embodiments, it can be stored in any character-oriented form, such as is shown in FIG. 4B.

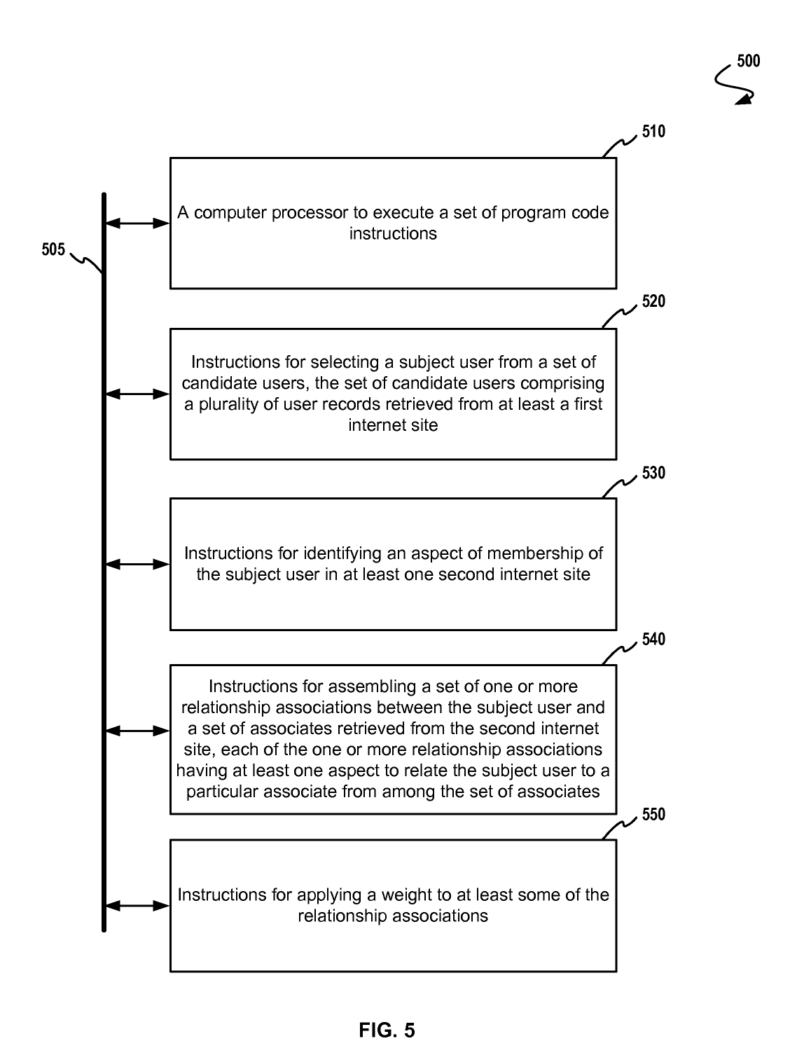

FIG. 5 depicts a block diagram of a system to perform certain functions of a computer system. As an option, the present system 500 may be implemented in the context of the architecture and functionality of the embodiments described herein. Of course, however, the system 500 or any operation therein may be carried out in any desired environment. As shown, system 500 comprises at least one processor and at least one memory, the memory serving to store program instructions corresponding to the operations of the system. As shown, an operation can be implemented in whole or in part using program instructions accessible by a module. The modules are connected to a communication path 505, and any operation can communicate with other operations over communication path 505. The modules of the system can, individually or in combination, perform method operations within system 500. Any operations performed within system 500 may be performed in any order unless as may be specified in the claims. The embodiment of FIG. 5 implements a portion of a computer system, shown as system 500, comprising a computer processor to execute a set of program code instructions (see module 510) and modules for accessing memory to hold program code instructions to perform: selecting a subject user from a set of candidate users, the set of candidate users comprising a plurality of user records retrieved from at least a first internet site (see module 520); identifying an aspect of membership of the subject user in at least one second internet site (see module 530); assembling a set of one or more relationship associations between the subject user and a set of associates retrieved from the second internet site, each of the one or more relationship associations having at least one aspect to relate the subject user to a particular associate from among the set of associates (see module 540); and applying a weight to at least some of the relationship associations (see module 550).

### Section III: Exemplary Practice of Embodiments

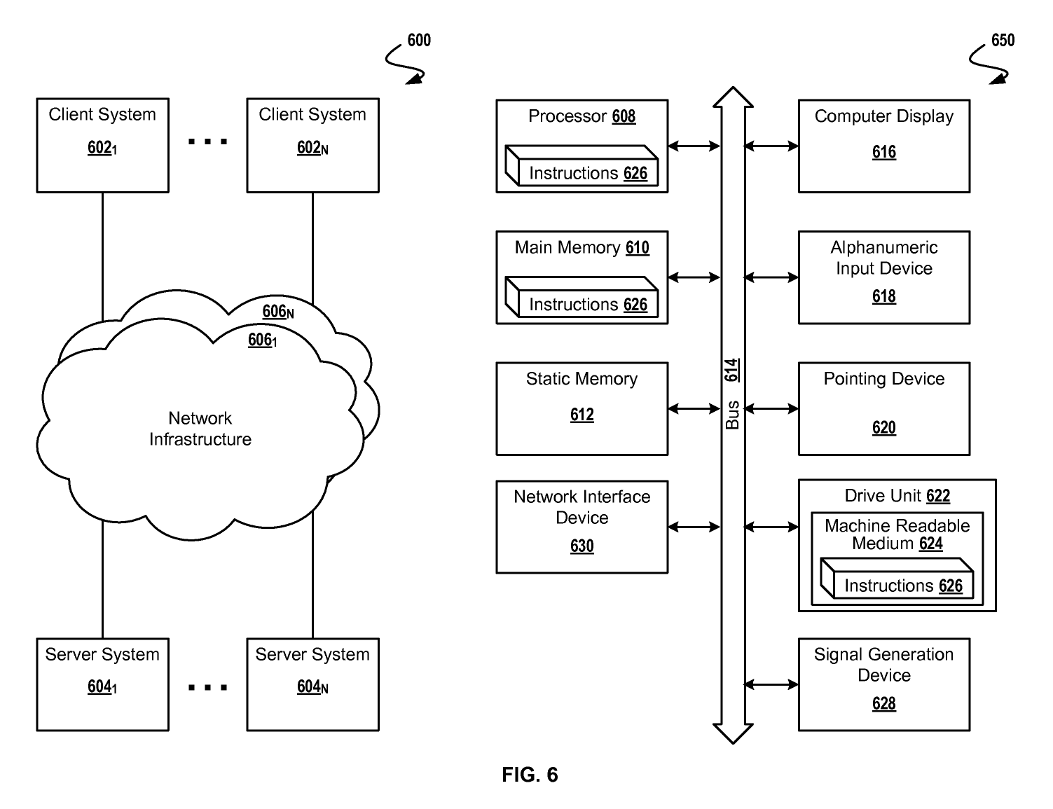

FIG. 6 depicts a computer system 600, for implementing embodiments. The computer system 600 includes nodes for client computer systems (e.g. client computer system 602₁ through client computer system 602_{N}), nodes for server computer systems (e.g. server computer system 604₁ through server computer system 604_{N}), and nodes for network infrastructure (e.g. network infrastructure node 606₁ through network infrastructure node 606_{N}), any of which nodes may comprise a machine (e.g. computer 650) within which a set of instructions for causing the machine to perform any one of the techniques discussed above may be executed. The embodiment shown is purely exemplary, and might be implemented in the context of one or more of the figures herein.

Any node of the network may comprise a general-purpose processor, a digital signal processor (DSP), an application specific integrated circuit (ASIC), a field programmable gate array (FPGA) or other programmable logic device, a discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems (including a processor and memory), a massively parallel computer system, and/or a cloud computer system.

The computer system (e.g. computer 650) includes a processor 608 (e.g. a processor core, a microprocessor, a computing device, etc), a main memory (e.g. computer memory 610), and a static memory 612, which communicate with each other via a bus 614. The computer 650 may further include a display unit (e.g. computer display 616) that may comprise a touch-screen, or a liquid crystal display (LCD), or a light emitting diode (LED) display, or a cathode ray tube (CRT). As shown, the computer system also includes a human input/output (I/O) device 618 (e.g. a keyboard, an alphanumeric keypad, etc), a pointing device 620 (e.g. a mouse, a touch screen, etc), a drive unit 622 (e.g. a disk drive unit, a CD/DVD drive, a tangible computer readable removable media drive, an SSD storage device, etc), a signal generation device 628 (e.g. a speaker, an audio output, etc), and a network interface device 630 (e.g. an Ethernet interface, a wired network interface, a wireless network interface, a propagated signal interface, etc).The drive unit 622 includes a machine-readable medium 624 on which is stored a set of instructions (i.e. software, firmware, middleware, etc) 626 embodying any one, or all, of the methodologies described above. The set of instructions 626 is also shown to reside, completely or at least partially, within the main memory and/or within the processor 608. The set of instructions 626 may further be transmitted or received via the network interface device 630 over the bus 614.

It is to be understood that embodiments of this disclosure may be used as, or to support, a set of instructions executed upon some form of processing core (such as the CPU of a computer) or otherwise implemented or realized upon or within a machine- or computer-readable medium. A machine-readable medium includes any mechanism for storing non-transitory information in a form readable by a machine (e.g. a computer). For example, a machine-readable medium includes read-only memory (ROM); random access memory (RAM); magnetic disk storage media; optical storage media; flash memory devices; and electrical, optical or acoustical or any other type of media suitable for storing non-transitory information.

While the figures and description have been described with reference to numerous specific details, one of ordinary skill in the art will recognize that the claimed embodiments can be differently embodied in other specific forms without departing from the scope of the claims.

We claim:

1. A computer implemented method for implementing a ranked user graph for social advertisement targeting, the method comprising:
selecting a subject user from a set of candidate users, the set of candidate users comprising a plurality of user records retrieved from at least a first internet site;
identifying an aspect of membership of the subject user in at least one second internet site;
assembling a set of one or more relationship associations between the subject user and a set of associates retrieved from the second internet site, each of the one or more relationship associations having at least one aspect to relate the subject user to a particular associate from among the set of associates; and
applying a weight to at least some of the relationship associations.

2. The method of claim 1, further comprising ranking the set of associates using at least the weight applied to one or more relationship associations.

3. The method of claim 1, further comprising filtering the set of associates to form a subset of the set of associates using at least the one or more relationship associations.

4. The method of claim 3, wherein filtering the set of associates comprises removing associates using at least some privacy actions.

5. The method of claim 3, wherein forming the subset of the set of associates comprises applying at least some user filters.

6. The method of claim 1, wherein identifying an aspect of membership uses a source ranking

7. The method of claim 1, further comprising forming a suggestion list based on the weight applied to at least some of the relationship associations.

8. An advertising network implementing a ranked user graph for social advertisement targeting, comprising:
a computer processor to execute a set of program code instructions; and
a memory to hold the program code instructions, in which the program code instructions comprises program code to perform,
selecting a subject user from a set of candidate users, the set of candidate users comprising a plurality of user records retrieved from at least a first internet site;
identifying an aspect of membership of the subject user in at least one second internet site;
assembling a set of one or more relationship associations between the subject user and a set of associates retrieved from the second internet site, each of the one or more relationship associations having at least one aspect to relate the subject user to a particular associate from among the set of associates; and
applying a weight to at least some of the relationship associations.

9. The advertising network of claim 8, further comprising ranking the set of associates using at least the weight applied to one or more relationship associations.

10. The advertising network of claim 8, further comprising filtering the set of associates to form a subset of the set of associates using at least the one or more relationship associations.

11. The advertising network of claim 10, wherein filtering the set of associates comprises removing associates using at least some privacy actions.

12. The advertising network of claim 10, wherein forming the subset of the set of associates comprises applying at least some user filters.

13. The advertising network of claim 8, wherein identifying an aspect of membership uses a source ranking.

14. The advertising network of claim 8, further comprising forming a suggestion list based on the weight applied to at least some of the relationship associations.

15. A computer program product embodied in a non-transitory computer readable medium, the computer readable medium having stored thereon a sequence of instructions which, when executed by a processor causes the processor to execute a method to implement a ranked user graph for social advertisement targeting, the method comprising:
selecting a subject user from a set of candidate users, the set of candidate users comprising a plurality of user records retrieved from at least a first internet site;
identifying an aspect of membership of the subject user in at least one second internet site;
assembling a set of one or more relationship associations between the subject user and a set of associates retrieved from the second internet site, each of the one or more relationship associations having at least one aspect to relate the subject user to a particular associate from among the set of associates; and
applying a weight to at least some of the relationship associations.

16. The computer readable medium of claim 15, further comprising ranking the set of associates using at least the weight applied to one or more relationship associations.

17. The computer readable medium of claim 15, further comprising filtering the set of associates to form a subset of the set of associates using at least the one or more relationship associations.

18. The computer readable medium of claim 17, wherein filtering the set of associates comprises removing associates using at least some privacy actions.

19. The computer readable medium of claim 17, wherein forming the subset of the set of associates comprises applying at least some user filters.

20. The computer readable medium of claim 15, further comprising forming a suggestion list based on the weight applied to at least some of the relationship associations.
